(19) United States
(12) Patent Application Publication
(10) Pub. No.: US 2019/0087815 A1
(43) Pub. Date: Mar. 21, 2019

(54) DIGITAL ENABLEMENT SERVICES FOR MERCHANT QR CODES

(71) Applicant: MasterCard International Incorporated, Purchase, NY (US)

(72) Inventor: David Goldschmidt, Aventura, FL (US)

(21) Appl. No.: 15/709,986

(22) Filed: Sep. 20, 2017

(51) Int. Cl. G06Q 20/36; G06Q 20/32; G06Q 20/20; G06Q 20/40

(52) U.S. Cl. CPC G06Q 20/3674; G06Q 20/4014; G06Q 20/204; G06Q 20/3276

(57) ABSTRACT

Methods, apparatus and systems for providing merchant quick response (QR) code services. In an embodiment, a digital enablement services (DES) computer receives a request for a merchant quick-response (QR) code from a merchant acquirer financial institution (FI) computer. The DES computer then determines that the merchant is registered and that the merchant's payment account number data falls within a qualifying bank identification number (BIN) range for tokenization. The DES computer then generates a merchant token by tokenizing the merchant payment account number, transmits merchant identification data and the merchant token to a QR code creator computer, receives a merchant QR code that includes the merchant identification information data and the merchant token, and then transmits the merchant QR code to the merchant acquirer FI computer for provision to the merchant to enable merchant QR code purchase transactions.

### FIELD OF THE DISCLOSURE

Embodiments described herein generally relate to methods and systems for protecting merchant-related information during quick-response (QR) code purchase transactions with consumers. More specifically, methods and systems are disclosed for generating a merchant QR code that includes a merchant identifier along with a merchant token for use to conduct purchase transactions, wherein the merchant token portion of the QR code is associated with the merchant's primary account number (PAN) (or with the merchant's payment account number).

### BACKGROUND

Portable electronic devices, such as smartphones, tablet computers, digital music players and the like, have been developed that include desirable functionality and thus the number of mobile device users and/or owners keeps growing. Such mobile devices can store all types of information, and can perform many different types of functions for users. The overall popularity of such mobile devices, especially smartphones, has led to the development of processes for using them to conduct financial transactions, for example, transmission of a payment between a payer (a consumer or payment card account holder or cardholder) and a recipient (or payee, such as a merchant or another cardholder).

A significant concern of payment systems is the protection of primary account numbers (PANs) from access by wrongdoers. Thus, an important initiative for preventing the unauthorized access to PANs involves the use of “tokenization,” to transform a PAN into a token for use in the payment process. Thus, tokens have been defined as “surrogate values that replace PANs” in part of a payment system. For example, a typical consumer credit card includes the cardholder's name, a sixteen-digit PAN, an expiration date and a security code, and any or all of this data can be “tokenized.” In a typical implementation, when a merchant swipes the magnetic stripe of a customer's payment card, the sixteen-digit PAN is automatically replaced with a randomly generated alphanumeric identifier (which is the “token”) stored thereon. The token, which appears to be a string of nonsensical letters and numbers, represents the cardholder's sixteen-digit account number, is then used to complete the purchase with a payment processor (which entity de-tokenizes the token to obtain the PAN). Such processing improves the payment security of the transaction.

According to one use case described in the Payment Token Interoperability Standard (issued by Mastercard International Incorporated (the assignee hereof), Visa and American Express in November 2013), a mobile device with NFC (Near Field Communication) capabilities is provisioned with a token. At the point of sale, the mobile device may pass the token and related information via NFC to a reader device associated with the merchant's point-of-sale (POS) terminal. An authorization request originates from the POS terminal and is routed via an acquiring financial institution (such as an acquirer bank) to a token service provider. The authorization request includes the token and other information, including an indication that the transaction was initiated via an NFC reader at the POS terminal. The token service provider maintains a secure database (sometimes referred to as a “token vault”) containing data for mapping tokens to their associated PANs. In some implementations, the token service provider also recognizes that the token in the authorization request is intended for use only in NFC transactions at a POS terminal, and thus in this use case the token is authorized. Accordingly, the token service provider replaces the token with the corresponding PAN (that the token represents) and then routes the authorization request (including the PAN and other information) to the issuer of the payment card account (identified by the PAN) for purchase transaction authorization processing. In order to conduct such processing, a cardholder's payment-enabled mobile device must include NFC circuitry, which can increase the price of a mobile device for consumers. In addition, the merchant must have NFC reader devices installed in his or her retail stores and a merchant system configured for handling such transactions. Thus, use cases have been developed that also utilize the Payment Token Interoperability Standard but do not involve NFC communication technology.

Processes are known wherein a payer utilizes a digital camera component of his or her mobile device to scan a code, such as a barcode or a quick-response (QR) code, at a merchant location in order to initiate a purchase transaction. A QR code is a machine-readable code consisting of an array of black and white squares, typically used for storing uniform resource locators (URLs) or other information for reading by the camera of a mobile device, such as a smartphone. For example, a retailer may have a sticker or label or sheet of paper having a two-dimensional merchant QR code printed thereon affixed to a countertop near a cash register (or on the cash register) at the merchant's retail store. In some embodiments, such a label or sticker having the merchant QR code printed on it may be provided to the merchant by a payment processing company (or by some other trusted third party), and can include merchant identification data and a merchant payment account number (associated with a financial account of the merchant). The merchant payment account number may be used for accepting payment for purchase transactions, and may be the merchant's actual payment account number (PAN). Thus, in some implementations, the consumer utilizes a payment application and the camera component of his or her mobile device to scan the merchant QR code, input a purchase transaction amount (the cost or price of the goods or services) and transmit a payment request so that funds can be transferred from the consumer's payment card account to the merchant's payment account (which may be processed by a payments system such as the Mastercard MoneySend™ or Mastercard Send™ platform). For such processing to be successful, both the merchant and the customer must be registered with a payments platform that accepts QR code transactions.

Mastercard International Incorporated, the assignee of the present application, has developed the “Mastercard Digital Enablement Service” (MDES) platform, which provides a suite of on-behalf-of (OBO) services that support the management, generation, and provisioning of digital payment credentials (such as tokens) into mobile devices. For example, the MDES platform generates and manages tokens, and can provide an EMV-like version of the merchant's account number. (“EMV” stands for Europay, Mastercard, Visa, and denotes a global standard for chip-based debit card account and credit card account transactions that ensures security and global acceptance of such accounts.) Thus, digital transactions carry cryptograms, dynamic data and the like for added security. The MDES platform therefore enables simpler, more secure digital payment experiences than those offered in the past, and was developed to facilitate the financial industry transition from consumer account credentials stored on traditional payment cards, to digital credentials provisioned into mobile devices. Digitized credentials enable the consumer's mobile device to perform payments via existing contactless point-of-sale systems and via new remote payment use cases, such as by utilizing in-app mobile device payments. Such digitization service-enhanced, device-based payment methods are designed to offer consumers simpler checkout and payment experiences, and to provide increased payment security.

The present inventors have recognized that there are opportunities for using existing digitization infrastructure, such as the MDES platform, to advantageously implement new digitization and tokenization processes in a manner that provides merchants with enhanced security for QR code purchase transactions.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate exemplary embodiments and which are not necessarily drawn to scale, wherein:

FIG. 1 is a block diagram illustrating components of a system for providing digitization and tokenization services to requestors in accordance with embodiments of the disclosure;

FIG. 2 is a block diagram of an embodiment of a purchase transaction system in accordance with the disclosure;

FIG. 3 is a block diagram of a consumer mobile device to illustrate aspects according to embodiments of the disclosure;

FIG. 4 is a block diagram of a digital enablement computer in accordance with aspects of the disclosure; and

FIG. 5 is a flowchart of a process for providing a merchant QR code to a merchant for securely conducting QR code purchase transactions according to aspects described herein.

### DETAILED DESCRIPTION

Reference will now be made in detail to various novel embodiments, examples of which are illustrated in the accompanying drawings. It should be understood that the drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

A number of terms will be used herein. The use of such terms is not intended to be limiting, but rather, the terms are used for convenience and ease of exposition. For example, as used herein, the term “cardholder” may be used interchangeably with the term “consumer” or “user” and are used herein to refer to a consumer, person, individual, business or other entity that owns (or is authorized to use) a financial account such as a payment card account (for example, a credit card account). In addition, the term “payment card account” may include a credit card account, a debit card account, and/or a deposit account or other type of financial account that an account holder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and related transactions, which may be operated by a payment card system operator such as Mastercard International Incorporated, or a similar system. In some embodiments, the term “payment card system” may be limited to systems in which member financial institutions (such as banks) issue payment card accounts to individuals, businesses and/or other entities or organizations.

In general, and for the purposes of introducing concepts of novel embodiments described herein, described are systems and processes for providing tokenization and digitization services for both static merchant quick-response (QR) codes and dynamic QR codes. In particular, in some embodiments, a system is provided that includes a digital enablement system (DES), a merchant acquirer financial institution (FI) computer, and a QR code creator computer. The system may also include a consumer's mobile device, a wallet provider (or trusted service manager) computer, a merchant device, a payment processing network, and a plurality of issuer FI computers. In an implementation, the DES computer receives a request for a merchant QR code from a merchant acquirer FI, which will be used to conduct purchase transactions with consumers. The merchant QR code request includes merchant credentials and a merchant payment account number (or primary account number (PAN)). The DES computer first determines whether or not the merchant is registered for the QR service, and if so, if the merchant payment account number (or merchant PAN) falls within a qualifying bank identification number (BIN) range for tokenization, as would be understood by one skilled in the art. If within the BIN range, the DES computer generates a merchant token by tokenizing the merchant PAN, and then (in some embodiments) transmits the merchant identification data and the merchant token to a QR code creator computer. The QR code creator generates a QR code that includes the merchant's identification data and the merchant token, and transmits that QR code to the DES computer. The DES computer then transmits the merchant QR code to the merchant acquirer FI computer for provision to the merchant so that QR code purchase transactions can be conducted between the merchant and consumers.

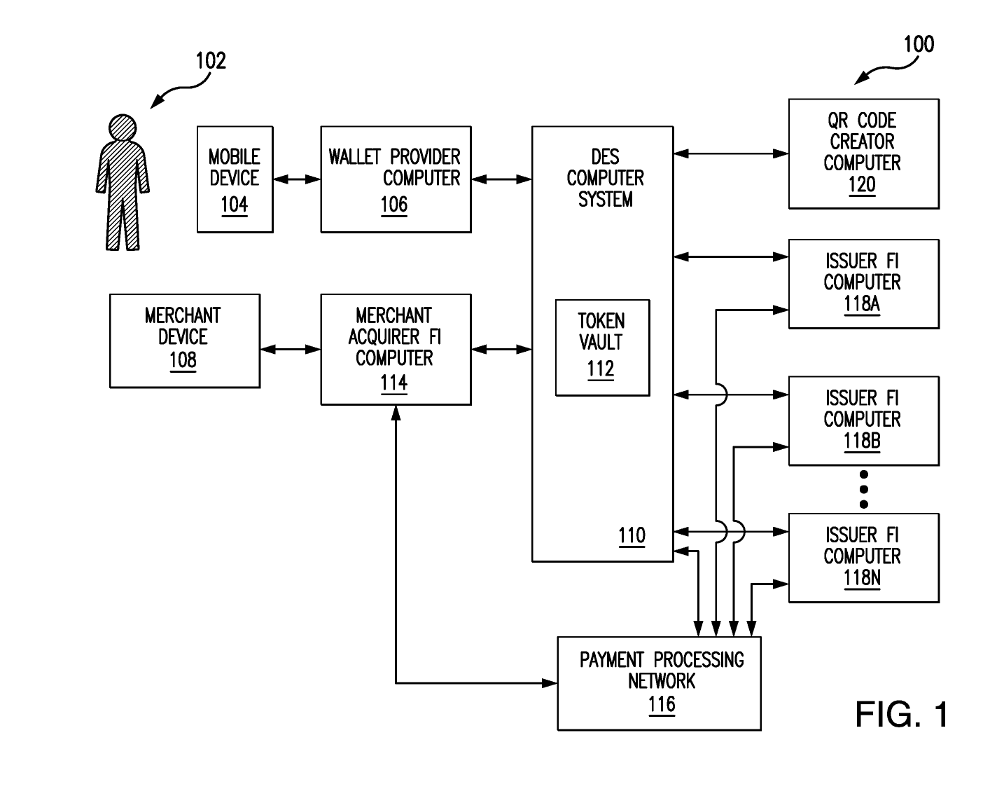

FIG. 1 is a block diagram that illustrates a system 100 in which teachings of the present disclosure may be applied. An individual user and/or cardholder is indicated by reference numeral 102 in FIG. 1, and the majority of such users 102 habitually carry with them mobile devices 104, such as smartphones, tablet computers, or the like. In some embodiments, the mobile device 104 is configured for communications with a wallet provider computer 106 (which may be a trusted service manager (TSM) computer). The mobile device 104 may also be configured for communicating with many types of other devices, such as other user mobile devices (not shown), for example, for exchanging audio and/or text messages and the like via a mobile network operator (“MNO”) system or the like (which is not shown in FIG. 1). In some implementations, communications between the consumer's mobile device 104 and the wallet provider computer 106 may occur through use of a private network or a public network and/or combinations thereof, for example, by using the Internet (not shown in FIG. 1).

Referring again to FIG. 1, a digital enablement service (DES) computer system 110 includes a token vault 112, and is operable to provide digitization and tokenization services to requestors. In accordance with the Payment Token Interoperability Standard, token requestors may include, for example, payment card account issuers (which include issuer financial institutions, such as banks), card-on-file merchants, acquirer financial institutions, original equipment manufacturer (OEM) device manufacturers, digital wallet providers, and trusted service managers (TSMs). In some embodiments, each such token requestor is required to register with the DES computer system 110 before requesting use of the token service. For example, merchant registration may entail the merchant providing merchant identification data (merchant name and business address, and the like), merchant payment account data (one or more financial account which may be accessed for receiving and/or making payments), security data, and the like data. In addition, as a provider of tokens, the DES computer system 110 may perform functions such as operate and maintain the token vault 112 (which stores token data, including token requester credentials and/or payment account data associated with the tokens), generate and issue tokens (in accordance with aspects of the present disclosure), assure security and proper controls, provision tokens, and register token requestors.

Referring again to FIG. 1, the DES computer system 110 is operably connected to the wallet provider computer 106, to a merchant's acquirer financial institution (FI) computer 114, to a payment processing network 116, to a plurality of issuer FI computers 118A, 118B to 118N, and optionally to a quick-response (QR) code creator computer 120. The merchant's acquirer FI computer 114 is associated with the financial institution (the merchant FI) that provides banking services to the merchant, and functions to receive and to route payment transaction authorization requests that originate from the merchant device 108.

FIG. 1 also includes a payment processing network 116, which may be the well-known Banknet® system operated by Mastercard International Incorporated (the assignee hereof), and which is operably connected to the merchant acquirer FI computer 114 and to the plurality of issuer FI computers 118A, 118B to 118N. Persons skilled in the art recognize that the issuer FI computers 118A, 118B to 118N typically represent banks or other financial institutions that provide banking services to users or consumers in addition to issuing payment accounts (for example, credit card accounts and/or debit card accounts) to the cardholders 102.

FIG. 1 also depicts a merchant device 108 operably connected to the merchant acquirer FI computer 114. The merchant device 108 may be, for example, a point-of-sale (POS) device such as an electronic cash register and the like, or may be a mobile device, such as a smartphone, configured for conducting transactions, including financial transactions (such as purchase transactions and/or payment transactions). It will be readily appreciated that a practical embodiment of the system 100 could include numerous merchants, token requestors, and acquirers FIs, rather than one of each as depicted in FIG. 1. It may also be the case that there is more than one token service provider and/or more than one QR code creator computer in the system 100.

The merchant device 108 shown in FIG. 1 may be associated with a merchant to which the consumer or cardholder 102 makes payment for goods and/or services. In accordance with embodiments disclosed herein, instead of the cardholder 102 presenting a payment card or a NFC-enabled mobile device to pay for a purchase, the consumer utilizes a camera component (not shown) of his or her mobile device 104 to read a QR code and obtain data associated with the merchant. The consumer then utilizes his or her mobile device 104 to transmit or “push” purchase transaction details into the system 100 to initiate a purchase transaction, as will be described in more detail below.

In some embodiments, the merchant device 108 may include a display component (not shown) operable to display a merchant QR code for use by a consumer to initialize a purchase transaction. In other implementations, the merchant QR code may be printed on a substrate that is placed in a convenient location within the merchant's retail store, for example, the QR code may be printed on a label that is affixed to a countertop of a checkout station.

In accordance with processes described herein, merchants who wish to offer QR code purchase transaction functionality must first register with the DES computer system 110 before a QR code can be obtained and/or assigned to the merchant. Thus, after the merchant has registered with the DES computer system 110 (by providing identification information and financial information, for example), in some embodiments the merchant utilizes his or her merchant device 108 to transmit a QR code request to the merchant's acquirer FI computer 114. The merchant acquirer FI computer 114 then assembles the merchant's credentials, which may include merchant identification information (such as the trade name and/or retail store name of the merchant), and determines which of the merchant's financial account(s) is/are eligible for tokenization. For example, the merchant acquirer FI computer 114 may check whether one or more of the merchant's payment account numbers falls within a BIN range that is eligible for tokenization, and then enable one or more of the merchant's payment card accounts for tokenization. Accordingly, a merchant's payment account number qualifies when the DES computer system 110 receives the account number and then determines that it has already been on-boarded by the DES computer system 110, and thus is eligible for tokenization. Referring again to FIG. 1, in some embodiments, after determining eligibility, the DES computer system 110 tokenizes the merchant's payment card account number and then transmits the merchant's QR code request, the merchant's credentials, and the token (the tokenized merchant payment account number) to a QR code creator computer 120. The QR code creator computer 120 receives the QR code request and accompanying data, and then generates a static QR code that includes machine readable data indicative of the merchant's identity and of the token (which is associated with the merchant's payment account number). The static QR code is then be provided by the DES computer system 110 to the merchant acquirer FI computer 114, which then electronically transmits it to the merchant device 108 for use by the merchant. For example, upon receipt, the merchant may printout a paper version of the QR code (possibly on a label) by using a local printer, and then display it in the retail store. Alternately, the merchant may store the QR code on his or her merchant device 108 and display the QR code on a display screen or computer monitor when a consumer wishes to initiate a purchase transaction. However, in some embodiments, the merchant acquirer FI 114 may receive and then printout the QR code on behalf of the merchant, and then mail the printed QR code on a sticker or label (for example) to the merchant for display in the merchant's retail store.

In some alternate embodiments, the merchant acquirer FI computer 114 receives the tokenized merchant payment account number from the DES computer system 110 directly, and then generates a static QR code. In this implementation, the merchant acquirer FI computer is configured for generating a QR code that includes machine readable data indicative of the merchant's identity and of the token (which represents the payment account number of the merchant). In this case, standards for creating the QR code may be provided by the DES computer system 110 to the merchant acquirer FI computer 114, which then generates and provides (or transmits) the QR code to the merchant, for example, via courier, mail and/or by electronic transmission to the merchant device 108.

It should also be understood that, in some implementations, during the tokenization process the DES computer system 110 can be configured to generate and provide an EMV-like version of the merchant's account number. For example, in addition to tokenizing the merchant account number, a cryptogram may be generated and added to the transaction data for use during the purchase transaction process, which provides added security. The cryptogram would then be utilized in the purchase transaction and would require decryption before the purchase transaction can be authorized and/or consummated.

As mentioned above, in some implementations, the store owner displays a physical representation of the merchant QR code in a convenient location, such as near a checkout station or retail store exit, for use by a consumer to initiate a purchase transaction. Alternatively, the merchant device may include a display component configured to display the merchant QR code upon demand. Since the static QR code includes the merchant name and a merchant token (which is associated with the merchant payment account number) the consumer's mobile device 104 never receives the merchant's actual PAN during a purchase transaction. Instead, when the merchant QR code is read, the consumer's mobile device obtains merchant identification data and a merchant token for use in processing the purchase transaction. As also mentioned above, the merchant QR code may be encrypted and thus requires decryption to consummate the purchase transaction.

In order to conduct QR-enabled purchase transactions, the cardholder 102 must first download a QR-enabled wallet application from the wallet provider computer 106 to his or her mobile device 104. In some implementations, when first downloaded and initialized on the consumers' mobile device 104, the QR wallet application prompts the user or cardholder to provide consumer registration information, which may include information such as the cardholder's name, billing address and the like. In addition, the consumer is then prompted to add a payment method, such as a credit card account or debit card account. In some embodiments, the consumer registration information and payment method (i.e., payment card account number, which may be the user's PAN associated with the cardholder's account) is transmitted to the DES computer system 110 for account enablement processing. Thus, in some implementations, the DES computer system 110 prepares provisioning data that is based on the cardholder registration information received from the wallet provider computer 106. In some implementations, the wallet provider computer 106 accepts the provisioning data from the DES computer system 110 and then transmits it to the mobile device 104 for storage in a secure element (not shown) of the consumer's mobile device 104. In some implementations, however, host card emulation (HCE) technology can be used instead, which is a software-based on-device technology that permits a mobile device to perform card emulation on an NFC-enabled device without relying on access to a secure element. In either case, the consumer 102 may then be able to use his or her mobile device 104 to engage in QR wallet application purchase transactions. It should be understood that tokenization of one or more of the consumer's payment card accounts occurs independently of the process(es) to tokenize one or more of the merchant's payment accounts to generate a merchant QR code, as described in this disclosure.

In some implementations, the consumer 102 need not be registered with the DES computer system 110. Instead, in some embodiments the cardholder 102 downloads a QR-enabled wallet application from the wallet provider computer 106 to his or her mobile device 104, with the mobile device being configured to read a merchant QR code. The mobile device 104 then utilizes a cardholder's payment account (stored in an electronic wallet such as a credit card account, which may be a “card on file” account, and thus non-tokenized) to generate and transmit a purchase transaction request.

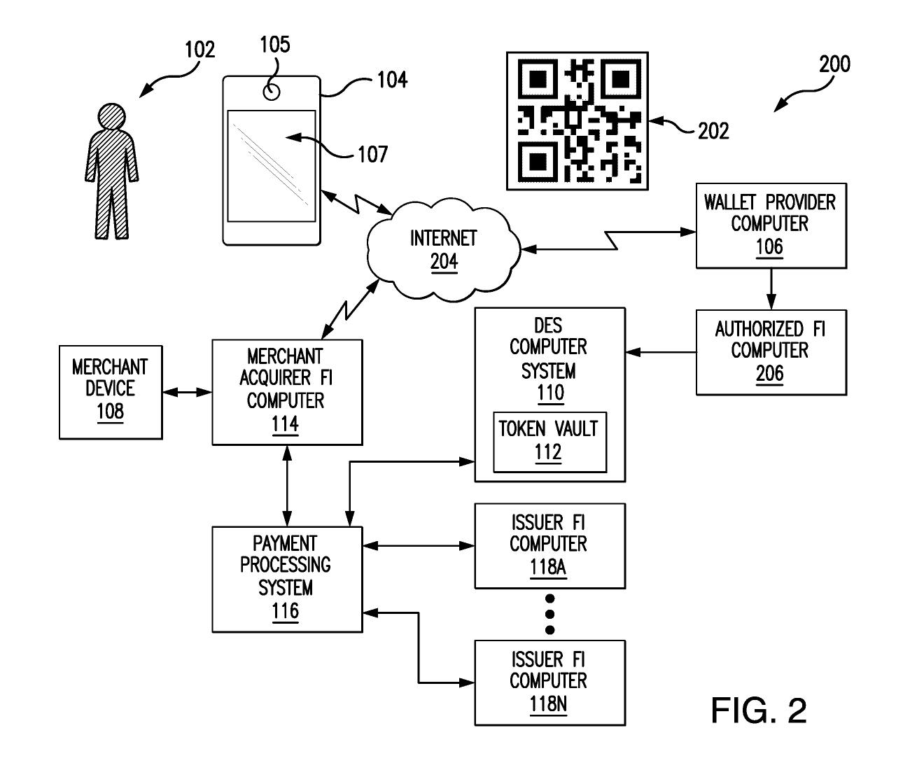

FIG. 2 depicts a block diagram of an embodiment of a QR code purchase transaction system 200 for illustrating a purchase transaction involving the use of a merchant QR code in accordance with processes described herein. An example of a merchant QR code 202 is depicted, and as explained herein is associated with the merchant and may be displayed in the merchant's retail store, or may be displayed on a display screen (not shown) of the merchant device 108. The QR code purchase transaction system 200 includes a user's mobile device 104 in the form of a smartphone having a camera component 105 and a touch screen 107 (but other types of mobile devices, such as laptop computers and/or tablet computers, may also be utilized). This example implementation may include a web browser to communicate with a wallet provider computer 106 (which may be a trusted service manager (TSM) computer) via the Internet 204. In some embodiments, the wallet provider computer 106 is operably connected to an authorized FI computer 206, which is operably connected to the DES computer system 110, which is also connected to a payment processing system 116. Also included in the QR code purchase transaction system 200 is a merchant device 108 operably connected to the merchant acquirer FI computer 114, which is also operably connected to the payment processing system 116. The payment processing system 116 is also operably connected to a plurality of issuer FI computers 118A-118N. For ease of understanding, FIG. 2 depicts only one payment processing system 116, but in reality a plurality of such payment processing systems would be included. Also, in some implementations, the DES computer system 110 may be configured for communications with other devices, such as with the merchant acquirer FI computer 114, with the wallet provider computer 106, and/or with the consumer's mobile device 104 via the Internet 204 (or some other type of network).

In some embodiments, to initialize a merchant QR code purchase transaction, the consumer 102 opens or initializes the QR wallet application stored in his or her mobile device 104, and then uses the camera component 105 to “take a picture” or to “read” the static merchant QR code 202, which is displayed in a merchant's retail store. As explained earlier, the merchant QR code 202 could be on a label mounted near or on a POS device at a checkout), or could be displayed on a display component (not shown) of the merchant device 108. Next, in some implementations, the QR wallet application translates the merchant identifier data portion of the merchant QR code 202 into the name of the merchant, and then displays the merchant's name on the display screen 107 (which may be a touch screen) for the consumer to read. The consumer 102 then may be prompted to confirm that the merchant's name is correct (for example, by touching an “Ok” or “Yes” confirmation button appearing on the touch screen 107 below or next to the merchant's name). After touching the confirmation button to provide a positive (“OK” or “Yes”) confirmation indication, in some implementations the QR wallet application then prompts the consumer 102 to input a payment amount in a “value-of-purchase” field that appears on the touch screen 107. The payment amount may be given to the consumer by the merchant or otherwise obtained by the consumer. This payment amount is then transmitted by the consumer's mobile device 104 to the wallet provider computer 106 for further processing.

For example, the consumer may bring several household items for purchase to a cashier station of a retail store, and a cashier may orally tell the consumer that the total cost of the items is forty-seven dollars and thirty-six cents (in U.S. currency). The consumer then initializes the merchant QR wallet application and utilizes the camera of his or her smartphone to read the merchant's QR code, confirms that the merchant's name appearing on the display screen is correct, enters $47.36 into a value-of-purchase field that appears, and then presses a “Pay Now” button to initiate the purchase transaction. At this stage the purchase transaction information is transmitted to the wallet provider computer, and the user or consumer.

Referring again to FIG. 2, in some embodiments when the consumer presses the “Pay Now” button appearing on the touch screen 107, the QR wallet application causes the cardholder's mobile device 104 to generate and transmit a purchase transaction request. The purchase transaction request may include the merchant token, the total cost of the purchase transaction, and the cardholder's payment credentials (which may be the PAN of the consumer and which need not be tokenized) via the Internet 204 to the wallet provider computer 106. Upon receipt of the purchase transaction request, the wallet provider computer 106 generates a “send to” message that includes the merchant token, the total cost of the purchase transaction, and the cardholder's payment credentials. The wallet provider computer 106 next transmits the “send to” message to an authorized FI computer 206, which is responsible for generating and transmitting a “push” payment message to the DES computer system 110. The push payment message directs payment from the consumer's payment card account to the merchant's financial account (held by the merchant's acquirer FI) that is associated with the merchant acquirer FI computer 114. Thus, upon receipt of the push payment message, the DES computer system 110 decrypts the merchant token and then maps the decrypted token data to data in the token vault 112 to determine the merchant's actual payment account number (the merchant's PAN, which may be associated with a payment card account held by the merchant acquirer FI), and generates a purchase transaction authorization request. The DES computer system 110 then transmits the purchase transaction authorization request (which includes the merchant's payment account number and an indication of the merchant's acquirer FI (the recipient account for receipt of payment of the transaction amount), the total cost of the transaction, and the consumer's payment card account number (or sending account) to the payment processing system 116 for purchase transaction processing. As is known, the payment processing system 116 receives the purchase transaction request and uses the received information to identify the consumer's issuer FI (for example, the issuer bank associated with the issuer FI computer 118A, shown in FIG. 1), then generates and transmits a purchase transaction authorization request to the customer's issuer FI computer 118A for authorization processing. If all is in order (i.e., the cardholder's payment card account contains sufficient funds (or sufficient credit) to cover the total cost of the purchase transaction), then the issuer FI computer 118A generates and transmits a purchase transaction authorization message back to the payment processing system 116. In some embodiments, the payment processing system 116 then transmits the payment authorization message to the merchant's acquirer FI computer 114 and to the consumer's mobile device 104 (if configured to do so). Settlement of the purchase transaction may occur at a later time, which includes debiting the consumer's payment card account and crediting the merchant's payment card account for the transaction amount. In some implementations, the merchant acquirer FI computer 114 then generates and transmits a payment received message to the merchant device 108 indicating that payment has been made for the purchase transaction.

In addition, in some embodiments the payment processing system 116 may transmit the payment authorization message to the DES computer system 110 for forwarding via the Internet 204 to the consumer's mobile device 104. In some implementations, instead of the DES computer system 110 receiving and then sending a payment authorization message to the consumer's mobile device, the merchant acquirer FI computer 114 (after receiving the purchase transaction authorization message), may be configured for generating and transmitting a payment approved message to the consumer's mobile device 104 via the Internet 204 indicating that payment has been made for the purchase transaction. Thus, in some embodiments, the cardholder 102 receives a payment confirmation message on the touch screen 107 indicating that payment was successful at about the same time, or substantially the same time, that the merchant receives the payment received message via a display component of the merchant device 108. The consumer is then permitted to exit the merchant's store with the purchased items.

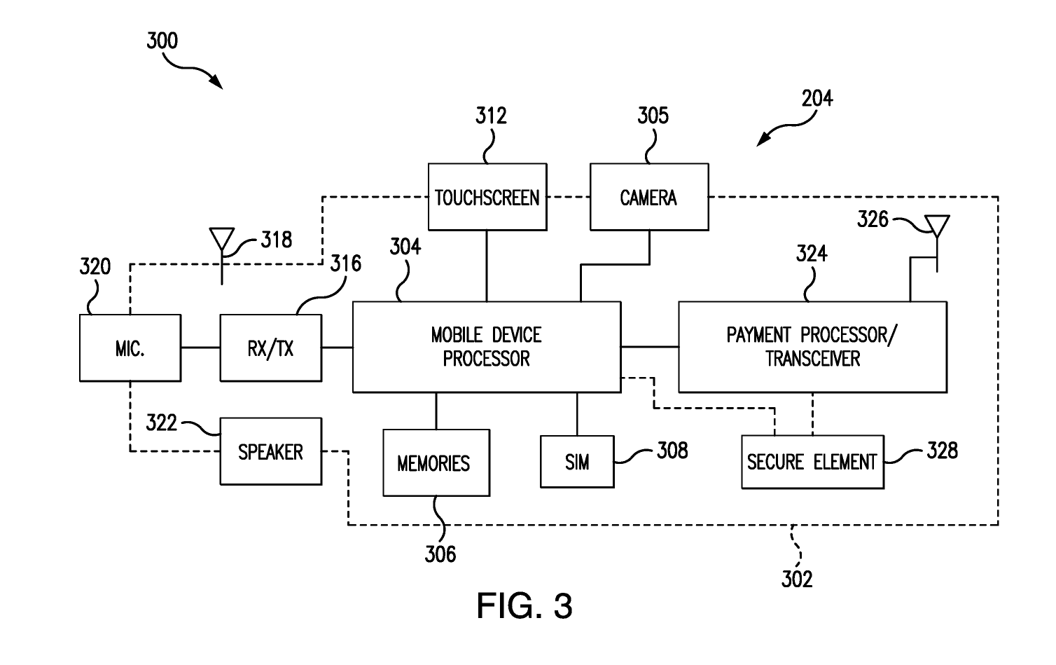

FIG. 3 is a block diagram of an embodiment of a mobile device 300 to illustrate some hardware aspects. In this example, the mobile device 300 is a smartphone used by a merchant and configured to display transaction information, such as a merchant QR code, in accordance with the methods described herein. The smartphone 300 could also be utilized by a consumer and configured for conducting purchase transactions in accordance with methods described herein. It should be understood that the smartphone 300 could be another type of device, such as a tablet computer or laptop, having wireless communications capability. In some embodiments, the novel functionality described herein may result at least partially from software and/or firmware that improves and/or transforms one or more components such as one or more controllers and/or processors of the smartphone 300.

The smartphone 300 may include a conventional housing (indicated by dashed line 302 in FIG. 3) that contains and/or supports the other components of the smartphone. The housing 302 may be shaped and sized to be held in a user's hand, and may for example exhibit the type of form factor that is common with the current generation of smartphones. The smartphone 300 further includes a mobile device processor 304 for controlling over-all operations.

Other components of the smartphone 300, which are in communication with and/or controlled by the mobile device processor 304, include one or more memory devices 306 (such as program and working memory, etc.), a conventional SIM (subscriber identification module) card 308, a camera 305, and a touchscreen 312 (which serves as the primary input/output device) for receiving input information from the user and for displaying output information to the user. The smartphone 104 may also include physically-actuatable switches and/or controls (not shown), such as an on/off/reset switch, a menu button, a “back” button, a volume control dial or switch, and the like.

The smartphone 300 also includes receive/transmit circuitry 316 that is also in communication with and/or controlled by the mobile device processor 304. The receive/transmit circuitry 316 is coupled to an antenna 318 and provides the communication channel(s) by which the smartphone 300 communicates via a mobile telephone communication network (not shown). Thus, the receive/transmit circuitry 316 may operate both to receive and transmit voice signals, in addition to performing data communication functions. As is known to those who are skilled in the art, such data communication may be via HTTP (HyperText Transfer Protocol) or other communication protocol suitable for carrying out data communication over the Internet and/or other types of computer networks.

The smartphone 300 further includes a microphone 320 coupled to the receive/transmit circuitry 316. Of course, the microphone 320 is for receiving voice input from the user. In addition, a speaker 322 is included to provide sound output to the user, and is coupled to the receive/transmit circuitry 316.

The receive/transmit circuitry 316 may operate in a conventional fashion to transmit, via the antenna 318, voice signals generated by the microphone 320, and to reproduce, via the speaker 322, voice signals received via the antenna 318. The receive/transmit circuitry 316 may also handle transmission and reception of text messages and other data communications via the antenna 318.

The smartphone 300 may also include a payment processor/transceiver 324 that is partly or wholly dedicated to implementing NFC communications functionality of the smartphone 300. Thus, the smartphone 300 may also include a loop antenna 326 coupled to the payment processor/transceiver 324. In some embodiments, the payment processor/transceiver 324 may partially overlap with the mobile device processor 304 of the smartphone 300. Moreover, the payment processor/transceiver 324 and the mobile device processor may be operably connected to a secure element 328. The term “secure element” is well known to those who are skilled in the art, and typically refers to a device that may include a small processor and volatile and/or nonvolatile memory (not separately shown) that is secured from tampering and/or reprogramming by suitable measures. In some embodiments, the secure element 328 may be provided as part of the SIM card 308. In other embodiments, the secure element 328 may be constituted by an integrated circuit card separate from the SIM card 308, but which may have the same or similar form factor as the SIM card 308. In some embodiments of the smartphone 300, the secure element 328 may be programmed in accordance with aspects of the present disclosure. (It should be noted that the term “secure element” is not intended to be limited to devices that are IC-based, but rather may also include any secure execution environment in a mobile device, and may include software based secure execution environments running, for example, on the mobile device processor 304.) According to aspects of the present disclosure, in some embodiments, a merchant token may be stored in the secure element 328 and utilized for generating and displaying the merchant QR code 202 (see FIG. 2) for reading by a customer's mobile device to initiate a purchase transaction. Alternately, in some embodiments the merchant's token may be stored in memory 306 (such as a hard drive) and retrieved to initiate a purchase transaction by using a cloud-based protocol, such as the Mastercard Cloud Based Payment (MCBP). In such a system, Single Use Keys are required, which are typically downloaded from a cloud-based computer network, to read the tokenized data.

It should also be understood that the smartphone 300 may be operable as a conventional mobile telephone for communication—both voice and data—over a conventional mobile telecommunications network, which is not depicted in FIGS. 1-3. Thus, the smartphone 300 may be in communication from time to time in a conventional manner with a mobile network operator (“MNO,” which is not shown).

As is familiar to those who are skilled in the art, the smartphone 300 may be viewed as a small computing device. Thus, the smartphone 300 device may include one or more processors that are programmed by software, apps and/or other processor-executable steps to provide functionality as described herein, both from the point of view of a merchant and that of a consumer with regard to a purchase transaction or the like. The software, apps and/or other processor-executable steps may be stored in one or more computer-readable storage media (such as the storage devices 306 and/or the secure element 328) and may comprise program instructions, which may be referred to as computer readable program code means.

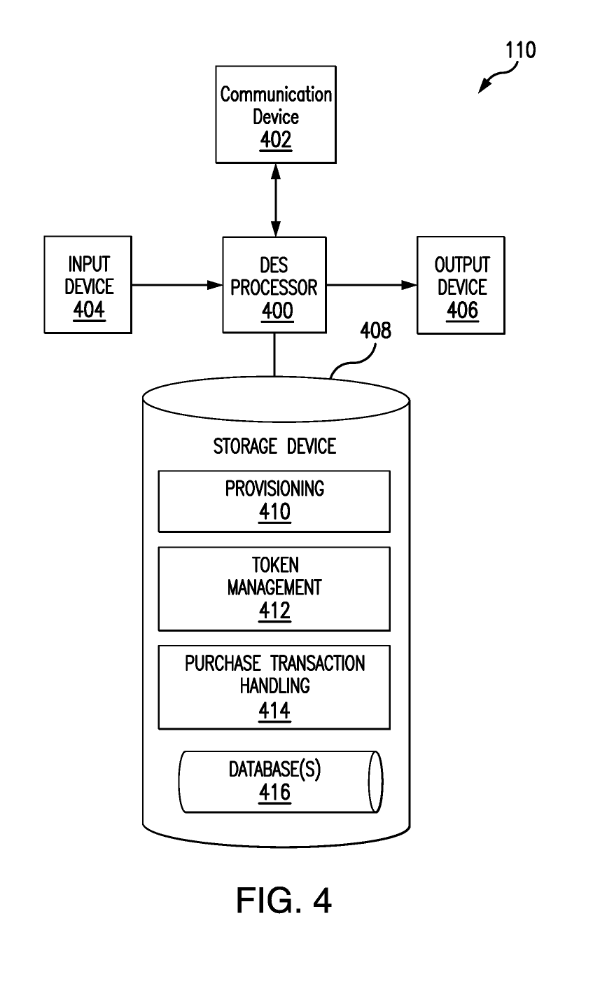

FIG. 4 is a block diagram that illustrates an example embodiment of a computer that embodies at least part of the functionality of DES computer system 110 which may be utilized in accordance with aspects of the present disclosure. The DES computer system 110 may include standard components and/or custom-designed and/or proprietary components in terms of its hardware and/or architecture, and may be controlled by software to cause it to function as described herein. For example, the DES computer system 110 may include server computer hardware.

The DES computer system 110 may include a DES processor 400 operatively coupled to a communication device 402, an input device 404, an output device 406, and a storage device 408. The DES processor 400 may be constituted by one or more processors, and operates to execute processor-executable steps, contained in program instructions described below, so as to control the DES computer system 110 to provide the desired functionality.

Communication device 402 may be used to facilitate communication with, for example, other devices (such as computers operated by acquirers and/or issuers, one or more wallet provider computers, a QR code generator computer, and one or more computers operated by the payment processing network, and numerous mobile devices such as the device 104 depicted in FIGS. 1 to 3). For example, communication device 402 may comprise numerous communication ports (not separately shown), to allow the DES computer system 110 to communicate simultaneously with a number of other computers and other devices, including communications as required to simultaneously process numerous purchase transactions and/or payment transactions. Thus, the communication device may be configured for wireless communications and/or wired communications via various different types of networks, such as the Internet.

Input device 404 may comprise one or more of any type of peripheral devices typically used to input data into a computer. For example, the input device 404 may include a keyboard and a mouse. Output device 406 may comprise, for example, a display and/or a printer. In some embodiments, the input device 404 and the output device 406 comprise a touch screen.

Storage device 408 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as flash memory and the like. Any one or more of such information storage devices may be considered to be a non-transitory computer-readable storage medium or computer usable medium or memory.

Storage device 408 stores one or more computer programs for controlling DES processor 400. The programs comprise program instructions (which may be referred to as computer readable program code means) that contain processor-executable process steps of the DES computer system 110, executed by the DES processor 400 to cause the DES computer system 110 to function as described herein.

The programs may include one or more conventional operating systems (not shown) that control the DES processor 400 to manage and coordinate activities and sharing of resources in the DES computer system 110, and to serve as a host for application programs that run on the DES computer system 110.

The storage device 408 may store a provisioning application program 410 that controls the DES processor 400 to enable the DES computer system 110 to provide provisioning services by which, for example, consumer payment accounts may be digitized into mobile devices in some implementations. The wallet applications and/or credential data provisioned by the DES computer system 110 to consumer mobile devices may support the features and/or functions as disclosed herein.

A token management application program 412 may also be stored in the storage device 408. The token management application program 412 may control the DES processor 400 to enable the DES computer system 110 to generate, activate, discard and/or otherwise manage the life cycles of tokens issued by the DES computer system 110, for example to merchants, in conjunction with the token vault 112 (see FIG. 1). Computer programs stored in the storage device 408 may also include a purchase transaction handling application program 414 that controls the DES processor 400 to enable the DES computer system 110 to handle transaction requests (such as purchase transaction requests) in a manner as described herein.

The storage device 408 may also store, and the DES computer system 110 may also execute, other programs, which are not shown. For example, such programs may include a confirmation reporting application, which transmits confirmation messages to wallet provider computers regarding successful purchase transaction processing performed by a payment network 116. Other programs can also include, e.g., one or more data communication programs, database management programs, device drivers, etc.

The storage device 408 may also store one or more databases 416 required for operation of the DES computer system 110. Such databases may include, for example, a database of issuer financial institution identification numbers (e.g., PAN-length BINs), and associated cryptographic keys and other data needed for the DES computer system 110 to properly generate and provide merchant QR tokens to merchants, and to properly process transaction requests.

In some embodiments, a dynamic merchant QR code may be provided for a particular purchase transaction, for example, by providing the transaction value in the merchant QR code (or any other type of information that changes). In such an implementation, a consumer selects several items and brings them to a checkout counter wherein a total value of the items is generated. The merchant then uses a smartphone (or other electronic device) to generate a merchant QR code that includes the total value of the transaction, and displays it on a display screen of his or her smartphone (or any other type of device capable of displaying the QR code) for reading by a camera component of the consumer's mobile device. Thus, in accordance with the methods described herein, the consumer scans the merchant QR code (which includes the total cost of the goods embedded therein) appearing on the merchant device display screen with the camera of his or her mobile device. The consumer then reads the merchant's name on the touch screen 107 of his or her mobile device, and then provides a positive reply to a “Pay Now” button appearing on the touch screen 107. The QR wallet application (running on the consumer's mobile device) then generates and transmits a purchase transaction request (which includes the merchant token, the total cost of the purchase transaction, and the cardholder's payment credentials via the Internet 204 to the wallet provider computer 106 (see FIG. 2). Subsequent purchase transaction processing then continues as described herein above.

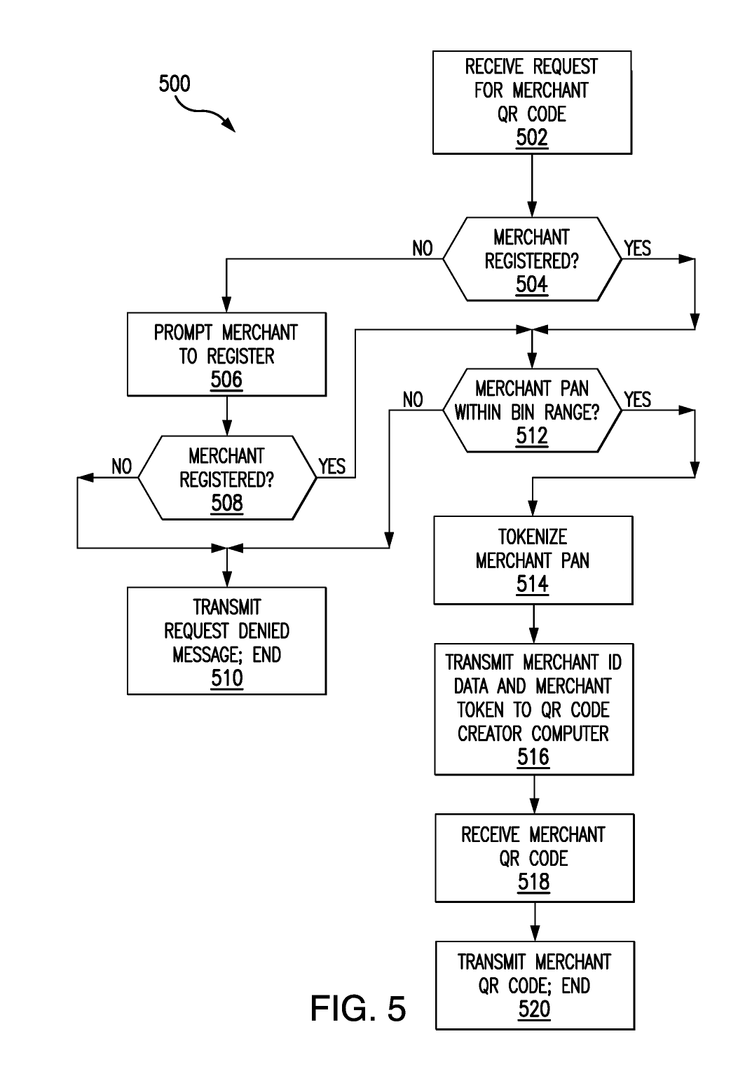

FIG. 5 is a flowchart illustrating a process 500 for providing a merchant QR code to a merchant for use in securely conducting merchant QR code purchase transactions in accordance with the processes described herein. A DES computer system receives 502 a request for a merchant QR code from a merchant acquirer FI computer, wherein the request includes merchant credentials and a merchant PAN or merchant payment account number. The DES computer then determines 504 whether or not the merchant is registered. If not, the DES computer prompts 506 the merchant to register for the QR code service. In some implementations, the DES computer idles for a predetermined amount of time (to give the merchant time to register) before again determining 508 whether or not the merchant has registered for the QR code service. If not, then the DES computer transmits 510 a merchant QR code service denied message to the merchant acquirer FI and the process ends. However, if the DES computer determines, in step 504 or in step 508, that the merchant is registered for the merchant QR code service, then the DES computer determines 512 whether or not the received merchant PAN is within a qualifying BIN range of payment card accounts for tokenization. In some embodiments, an acquirer financial institution (which may be associated with the acquirer FI computer 114; see FIG. 1) is the entity that notifies the DES computer system that a particular set of merchants (which have accounts within a BIN range) are eligible for QR code services.

Referring again to FIG. 5, if in step 512 the merchant PAN is not within a qualifying BIN range, then the DES computer transmits 510 a merchant QR code request denied message to the merchant acquirer FI, and the process ends. But if in step 512 the DES computer system determines that the merchant PAN is within a qualifying BIN range for tokenization, then the DES computer generates 514 a merchant token by tokenizing the merchant payment account number. The DES computer then transmits 516 the merchant identification data and the merchant token to a QR code creator computer. Upon receipt, the QR code creator computer generates a merchant QR code that includes the merchant identification data and the merchant token. Next, the DES computer receives 518 from the QR code creator computer, a merchant QR code that includes the merchant identification information and the merchant token, and then transmits 520 the merchant QR code to the merchant acquirer FI computer, which then provides it to the merchant for permitting merchant QR code purchase transactions.

In some embodiments of the process 500, the DES computer also stores the merchant token, after generating it, along with the associated merchant payment account number in a token vault. In addition, after the merchant has received the merchant QR code and displayed it (for example, on a label near a point of sale device, or on a display screen of a point of sale device) for use in purchase transaction processing, the DES computer receives, from an authorized FI computer, a push payment request that includes the merchant token, a consumer payment card account number, and a purchase transaction amount. As described earlier, the DES computer then de-tokenizes the merchant token to obtain the merchant's payment account number, transmits a payment request that includes the consumer credentials and the merchant payment account number to a payment processing computer, and receives a payment authorization message indicating successful purchase transaction processing from the payment processing computer. In some implementations, the DES computer then generates and transmits a payment confirmation message to the authorized FI computer, which is associated with the wallet provider computer, for transmission to the consumer's mobile device.

The merchant QR code processes disclosed herein provide an efficient and robust method for protecting merchant-related information. In particular, the merchant QR code that is utilized in a purchase transaction contains a token that is associated with the merchant's PAN (or merchant's payment account number). As a result, the merchant PAN is inaccessible to the consumer, to the wallet provider, and to any other originating institution that may generate the “pay to” request during transaction processing. The DES computer system de-tokenizes the merchant token, and then maps it to data in a token vault to obtain the merchant's actual PAN before submitting a purchase transaction authorization request to a payment network for transaction processing. This mapping is not visible to the QR code wallet application running on the customer's mobile device, to the wallet provider computer, or to any originating financial institution performing the “push payment.” In addition, for added security, in some embodiments the merchant QR code includes EMV-like components, such as a cryptogram and/or dynamic validation data, which must be decrypted and or otherwise validated to successfully consummate the purchase transaction. Again, as mentioned above, the DES computer system is employed to map the merchant token to the merchant's payment account number, and such mapping is not visible to the QR code wallet application, to the wallet provider computer, or to any originating institution performing the “push payment.”

In addition to the security benefits, in some embodiments the processes disclosed herein adhere to global standards for electronically securing payment credentials, and are cost effective because existing payment account infrastructure can be used (such as existing payment card networks). Furthermore, an existing merchant QR code that has been generated in accordance with the methods described herein need not be changed if the merchant opens a new merchant account. Instead, the DES computer system need only change the mapping in the token vault to represent the new merchant account.

As used herein and in the appended claims, the term “computer” should be understood to encompass a single computer or two or more computers in communication with each other or a computer network or computer system. In addition, as used herein and in the appended claims, the term “processor” should be understood to encompass a single processor or two or more processors in communication with each other. Moreover, as used herein and in the appended claims, the term “memory” should be understood to encompass a single memory or storage device or two or more memories or storage devices. Such a memory and/or storage device may include any and all types of non-transitory computer-readable media, with the sole exception being a transitory, propagating signal.

The flow charts and descriptions thereof herein should not be understood to prescribe a fixed order of performing the method steps described therein. Rather, the method steps may be performed in any order that is practicable. In addition, the flow charts described herein should not be understood to require that all steps or elements be practiced in every embodiment. For example, one or more elements or steps may be omitted in some embodiments.

Although the present disclosure describes specific exemplary embodiments, it should be understood that various changes, substitutions, and alterations apparent to those skilled in the art can be made to the disclosed embodiments without departing from the spirit and scope of the disclosure as set forth in the appended claims.

what is claimed is:

1. A method for providing a merchant quick response (QR) code comprising:
receiving, by a digital enablement services (DES) computer from a merchant acquirer financial institution (FI) computer, a request for a merchant quick-response (QR) code, the request including merchant identification data and merchant payment account number data;
determining, by the DES computer, that the merchant is registered for a merchant QR code service and that the merchant payment account number data falls within a qualifying bank identification number (BIN) range for tokenization;
generating, by the DES computer, a merchant token by tokenizing the merchant payment account number;
transmitting, by the DES computer, merchant identification data and the merchant token to a QR code creator computer;
receiving, by the DES computer from the QR code creator computer, a merchant QR code that includes the merchant identification information data and the merchant token; and
transmitting, by the DES computer to the merchant acquirer FI computer, the merchant QR code for provision to the merchant to enable merchant QR code purchase transactions.

2. The method of claim 1, further comprising, after generating the merchant token, storing, by the DES computer, the merchant token along with the associated merchant payment account number in a token vault.

3. The method of claim 1, further comprising:
receiving, by the DES computer from an authorized financial institution computer, a push payment request comprising the merchant token, consumer payment card account data, and a purchase transaction amount;
mapping, by the DES computer, the merchant token data to data stored in a token vault and obtaining a merchant payment account number;
transmitting, by the DES computer to a payment processing computer, a purchase transaction authorization request comprising the consumer payment card account data, the transaction amount, and the merchant payment account number; and
receiving, by the DES computer from the payment processing computer, a payment confirmation message indicating successful purchase transaction processing.

4. The method of claim 3, further comprising transmitting, by the DES computer to the authorized financial institution computer, the payment confirmation message.

5. The method of claim 3, wherein the authorized financial institution computer comprises one of a wallet provider computer or a trusted service manager computer.

6. The method of claim 1, wherein the request for a merchant QR code further comprises a transaction value, and further comprising, after generating the merchant token:
transmitting, by the DES computer, merchant identification data, the merchant token and the transaction value to the QR code creator computer;
receiving, by the DES computer from the QR code creator computer, a dynamic merchant QR code that includes the merchant identification information data, the transaction value, and the merchant token; and
transmitting, by the DES computer to the merchant acquirer FI computer, the dynamic merchant QR code for provision to a merchant device to enable a dynamic merchant QR code purchase transaction.

7. The method of claim 1, further comprising, after receiving the request for a merchant quick-response (QR) code:
determining, by the DES computer, that the merchant is not registered for a merchant QR code service;
transmitting, by the DES computer to the merchant acquirer FI computer, a message to prompt the merchant to register for merchant QR code services; and
receiving, by the DES computer from the merchant acquirer FI computer, merchant registration data for use when providing merchant QR code services.

8. The method of claim 1, further comprising, after receiving the request for a merchant quick-response (QR) code:
determining, by the DES computer, that the merchant payment account number data does not fall within the qualifying BIN range for tokenization;
generating, by the DES computer, a merchant QR code service denied message; and
transmitting, by the DES computer to the merchant acquirer FI computer, the merchant QR code service denied message for provision to the merchant.

9. A digital enablement services (DES) computer comprising:
a DES processor;
a communication device operably connected to the DES processor; and
a storage device operably connected to the DES processor and storing instructions configured to cause the DES processor to:
receive a request for a merchant quick-response (QR) code from a merchant acquirer financial institution (FI) computer, the merchant QR code request including merchant identification data and merchant payment account number data;
determine that the merchant is registered for a merchant QR code service;
determine that the merchant payment account number data falls within a qualifying bank identification number (BIN) range for tokenization;
generate a merchant token by tokenizing the merchant payment account number;
transmit merchant identification data and the merchant token to a QR code creator computer;
receive a merchant QR code from the QR code creator computer, the merchant QE code including the merchant identification information data and the merchant token; and
transmit the merchant QR code to the merchant acquirer FI computer for forwarding to the merchant to enable merchant QR code purchase transactions.

10. The apparatus of claim 9, wherein the storage device stores further instructions, after the instructions for generating the merchant token, configured to cause the DES processor to store the merchant token along with the associated merchant payment account number in a token vault.

11. The apparatus of claim 9, wherein the storage device stores further instructions configured to cause the DES processor to:
receive a push payment request from an authorized financial institution computer, the push payment request comprising the merchant token, consumer payment card account data, and a purchase transaction amount;
map the merchant token data to data stored in a token vault and obtaining a merchant payment account number;
transmit a purchase transaction authorization request to a payment processing computer, the purchase transaction authorization request comprising the consumer payment card account data, the transaction amount, and the merchant payment account number; and
receive a payment confirmation message from the payment processing computer indicating successful purchase transaction processing.

12. The apparatus of claim 11, wherein the storage device stores further instructions configured to cause the DES processor to transmit the payment confirmation message to the authorized financial institution computer.

13. The apparatus of claim 11, wherein the authorized financial institution computer comprises one of a wallet provider computer or a trusted service manager computer.

14. The apparatus of claim 9, wherein the storage device stores further instructions configured to cause the DES processor to further receive a transaction value along with the request for a merchant QR code, and further comprises instructions, after the instructions for generating the merchant token, to cause the DES processor to:
transmit the merchant identification data, the merchant token and the transaction value to the QR code creator computer;
receive a dynamic merchant QR code from the QR code creator computer, the dynamic QR code comprising the merchant identification information data, the transaction value, and the merchant token; and
transmit the dynamic merchant QR code to the merchant acquirer FI computer for provision to a merchant device to enable a dynamic merchant QR code purchase transaction.

15. The apparatus of claim 9, wherein the storage device stores further instructions configured to cause the DES processor to:
determine that the merchant is not registered for a merchant QR code service;
transmit a message to the merchant acquirer FI computer to prompt the merchant to register for merchant QR code services; and
receive merchant registration data from the merchant acquirer FI computer for use to provide merchant QR code services.

16. The apparatus of claim 9, wherein the storage device stores further instructions configured to cause the DES processor to:
determine that the merchant payment account number data does not fall within the qualifying BIN range for tokenization;
generate a merchant QR code service denied message; and
transmit the merchant QR code service denied message to the merchant acquirer FI computer for provision to the merchant.

17. A system for providing merchant quick-response (QR) code services comprising:
a digital enablement services (DES) computer comprising a DES processor, a communication device operably connected to the DES processor, and a storage device operably connected to the DES processor;
a merchant acquirer financial institution (FI) computer operably connected to the DES computer;
a QR code creator computer operably connected to the DES computer; and
a merchant device operably connected to the merchant acquirer FI computer;
wherein the storage device of the DES computer stores instructions configured to cause the DES processor to:
receive a request for a merchant quick-response (QR) code from the merchant acquirer FI computer, the merchant QR code request including merchant identification data and merchant payment account number data;
determine that the merchant is registered for a merchant QR code service;
determine that the merchant payment account number data falls within a qualifying bank identification number (BIN) range for tokenization;
generate a merchant token by tokenizing the merchant payment account number;
transmit merchant identification data and the merchant token to the QR code creator computer;
receive a merchant QR code from the QR code creator computer, the merchant QE code including the merchant identification information data and the merchant token; and
transmit the merchant QR code to the merchant acquirer FI computer for forwarding to the merchant device to enable merchant QR code purchase transactions.

18. The system of claim 17, wherein the storage device further comprises a token vault, and wherein the storage device stores further instructions configured to cause the DES processor to store the merchant token along with the associated merchant payment account number in the token vault.

19. The system of claim 17, further comprising:
an authorized FI computer operably connected to the DES computer; and
a payment processing computer operably connected to the DES computer;
wherein the storage device of the DES computer stores further instructions configured to cause the DES processor to:
receive a push payment request from the authorized FI computer, the push payment request comprising the merchant token, consumer payment card account data, and a purchase transaction amount;
map the merchant token data to data stored in a token vault and obtaining a merchant payment account number;
transmit a purchase transaction authorization request to the payment processing computer, the purchase transaction authorization request comprising the consumer payment card account data, the transaction amount, and the merchant payment account number; and
receive a payment confirmation message from the payment processing computer indicating successful purchase transaction processing.

20. The system of claim 19, wherein the storage device stores further instructions configured to cause the DES processor to transmit the payment confirmation message to the authorized financial institution computer.

21. The system of claim 19, wherein the authorized financial institution computer comprises one of a wallet provider computer or a trusted service manager computer.

22. The system of claim 17, wherein the storage device stores further instructions configured to cause the DES processor to further receive a transaction value along with the request for a merchant QR code, and further comprises instructions to cause the DES processor to:
transmit the merchant identification data, the merchant token and the transaction value to the QR code creator computer;
receive a dynamic merchant QR code from the QR code creator computer, the dynamic QR code comprising the merchant identification information data, the transaction value, and the merchant token; and
transmit the dynamic merchant QR code to the merchant acquirer FI computer for provision to the merchant device to enable a dynamic merchant QR code purchase transaction.

23. The system of claim 17, wherein the storage device stores further instructions configured to cause the DES processor to:
determine that the merchant is not registered for a merchant QR code service;
transmit a message to the merchant acquirer FI computer to transmit a message to the merchant device to prompt the merchant to register for merchant QR code services; and
receive merchant registration data from the merchant acquirer FI computer for use to provide merchant QR code services.

24. The system of claim 17, wherein the storage device stores further instructions configured to cause the DES processor to:
determine that the merchant payment account number data does not fall within the qualifying BIN range for tokenization;
generate a merchant QR code service denied message; and
transmit the merchant QR code service denied message to the merchant acquirer FI computer for transmission to the merchant device.
